(19) United States
(12) Patent Application Publication
(10) Pub. No.: US 2012/0190402 A1
(43) Pub. Date: Jul. 26, 2012

(54) DUAL MODE MOBILE TERMINAL IN WIRELESS COMMUNICATION SYSTEM AND CONTROLLING METHOD THEREOF

(76) Inventors: Yongnam WHANG, Uiwang-si (KR); Sunmi Kim, Seoul (KR)

(21) Appl. No.: 13/195,957

(22) Filed: Aug. 2, 2011

Related U.S. Application Data
(60) Provisional application No. 61/435,354, filed on Jan. 24, 2011.

(30) Foreign Application Priority Data
Jun. 23, 2011 (KR) 10-2011-0060976

(51) Int. Cl. H04W 88/06

(52) U.S. Cl. 455/552.1

(57) ABSTRACT

A dual mode mobile terminal in a wireless communication system is disclosed. The present invention includes a first communication module configuring to transceive a signal with an LTE (long term evolution) network, a second communication module configuring to transceive a signal with a CDMA (code divisional multiple access) eHRPD (enhanced high-rate packet data) network, and a processor configured to process the signal corresponding to the first communication module and the signal corresponding to the second communication module, the processor, when the first communication module is activated, controlling a signal transmission event to the CDMA eHRPD network to be performed only if an RRC (radio resource control) connection to the LTE network is disconnected.

This application claims the benefit of the U.S. Provisional Application No. 61/435,354, filed on Jan. 24, 2011, and the Korean Patent Application No. 10-2011-0060976, filed on Jun. 23, 2011, which are hereby incorporated by reference as if fully set forth herein.

### BACKGROUND OF THE INVENTION

1. Field of the Invention

The present invention relates to a wireless communication system, and more particularly, to a dual mode mobile terminal in a wireless communication system and controlling method thereof.

2. Discussion of the Related Art

Recently, the wireless communication fields consistently keep being evolved in aspect of fast data transmission and reception as well as voice call. And, ongoing attentions are paid to the 4^{th} generation mobile communication technology, e.g., LTE (long term evolution) wireless communication system. Yet, in a current situation that the 4^{th} generation communication network and the commercialized 3^{rd} generation communication network coexist, a mobile communication terminal or a mobile communication data card should include the 3G mobile communication technology, which is already commercialized and being used globally, as well as the 4^{th} generation mobile communication technology. Therefore, in order to support both of the next generation mobile communication technology and the previous generation mobile communication technology, a mobile terminal (hereinafter called a dual mode terminal) equipped with a dual modem processor or a data card type device (hereinafter called a dual mode terminal) equipped with a dual modem processor is required.

The dual mode terminal is equipped with two kinds of modems differing from each other in communication scheme and supports the wireless communications using the two kinds of the modems, respectively. And, the dual mode terminal is frequently used in an area in which heterogeneous communication networks coexist. For example of a representative dual mode terminal, attention is paid to a device capable of both LTE (long term evolution) wireless communication and eHRPD (enhanced high-rate packet data) wireless communication. In this case, the eHRPD is a new version of 1xEV-DO higher layer protocol stack developed by 3GPP2 Standard Committee to prepare for the wireless communication network mutual operability with LTE in CDMA. Although the description of the present invention is made on the assumption of a multi-mode device capable of communicating with both LTE network and CDMA network, it is apparent to those skilled in the art that the present invention is applicable to wireless communications of other systems.

### SUMMARY OF THE INVENTION

Accordingly, the present invention is directed to a dual mode mobile terminal in a wireless communication system and controlling method thereof that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dual mode terminal in a wireless communication system according to one embodiment of the present invention includes a first communication module configuring to transceive a signal with an LTE (long term evolution) network, a second communication module configuring to transceive a signal with a CDMA (code divisional multiple access) eHRPD (enhanced high-rate packet data) network, and a processor configured to process the signal corresponding to the first communication module and the signal corresponding to the second communication module, the processor, when the first communication module is activated, controlling a signal transmission event to the CDMA eHRPD network to be performed only if an RRC (radio resource control) connection to the LTE network is disconnected.

Preferably, the dual mode terminal further includes a buffer configured to save a presence or non-presence of an occurrence of the signal transmission event to the CDMA eHRPD network if the RRC connection to the LTE network is maintained in case of the occurrence of the signal transmission event to the CDMA eHRPD network.

More preferably, if the RRC connection to the LTE network is disconnected, the processor controls the signal transmission event to the CDMA eHRPD network, which is saved in the buffer, to be performed.

Preferably, when an occurrence of the signal transmission event to the CDMA eHRPD is detected, if a sum of a transmission power to the LTE network and a transmission power to the CDMA eHRPD network is smaller than a preset value, the processor controls the signal transmission event to the CDMA eHRPD network to be performed.

In another aspect of the present invention, a method of controlling a dual mode terminal in a wireless communication system includes the steps of activating a first communication module configuring to transceive a signal with an LTE (long term evolution) network, detecting an occurrence of a signal transmission event to the CDMA eHRPD network by a second communication module configuring to transceive a signal with a CDMA (code divisional multiple access) eHRPD (enhanced high-rate packet data) network, determining a presence or non-presence of an RRC (radio resource control) connection to the LTE network, and if the RRC connection is disconnected, performing the signal transmission event to the CDMA eHRPD network in the second communication module.

Preferably, the method further includes the step of saving a presence or non-presence of the occurrence of the signal transmission event to the CDMA eHRPD network if the RRC connection to the LTE network is maintained in case of the occurrence of the signal transmission event to the CDMA eHRPD network.

More preferably, the method further includes the step of if the RRC connection to the LTE network is disconnected, performing the signal transmission event to the CDMA eHRPD network.

Preferably, the method further includes the step of when the occurrence of the signal transmission event to the CDMA eHRPD is detected, if a sum of a transmission power to the LTE network and a transmission power to the CDMA eHRPD network is smaller than a preset value, performing the signal transmission event to the CDMA eHRPD network.

Preferably, the signal transmission event to the CDMA eHRPD network in the second communication module is a subnet change event for the dual mode terminal or a CDMA eHRPD session reconfiguration event.

Accordingly, the present invention provides the following effects and/or advantages.

First of all, the present invention enabling a terminal to prevent an unnecessary power back-off by satisfying the SAR regulations.

Secondly, the present invention is able to reduce overall handover time when a terminal performs a handover between heterogeneous networks.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptional diagram of a network structure of E-UMTS;

FIG. 2 is a conceptional diagram of a network structure of E-UTRAN (evolved universal terrestrial radio access network);

FIG. 3 and FIG. 4 are diagrams of structures of control and user planes of a radio interface protocol between a user equipment and E-UTRAN based on 3GPP radio access network specification;

FIG. 5 is a conceptional block diagram for a configuration of a dual mode terminal;

FIG. 6 is a diagram for a configuration of a dual mode terminal according to the present invention; and

FIG. 7 is a flowchart for an operation of a dual mode terminal according to an embodiment of the present invention.

### DETAILED DESCRIPTION OF THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes 3GPP LTE system, they are applicable to other random mobile communication systems except unique features of 3GPP LTE.

Occasionally, to prevent the concept of the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), a mobile handset and the like. And, assume that a base station is a common name of such a random node of a network stage communicating with a terminal as a node B, eNode B, a base station and the like.

First of all, in the following description, E-UMTS (evolved universal mobile telecommunication system), to which the present invention is applicable, and technical features related to E-UMTS are explained.

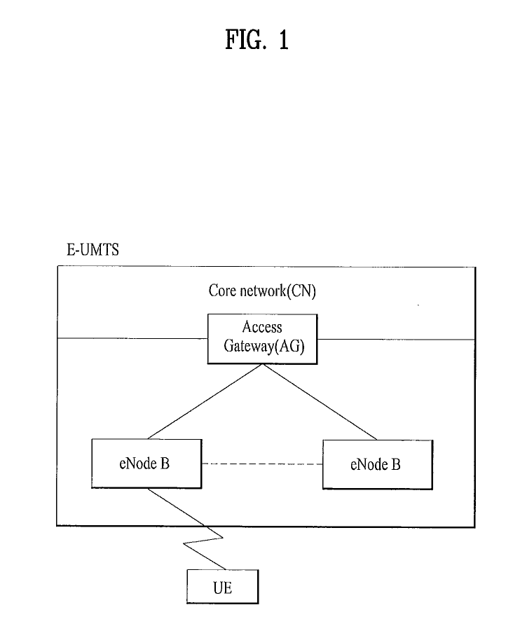

FIG. 1 is a conceptional diagram of a network structure of E-UMTS. First of all, E-UMTS (evolved universal mobile telecommunications system) is the system evolved from a conventional WCDMA UMTS (universal mobile telecommunications system) and its basic standardization is progressing by 3GPP. Generally, E-UMTS can be called LTE (long term evolution) system. For the details of the technical specifications of UMTS and E-UMTS, Release 7 and Release 8 of ‘3^{rd} Generation Partnership Project: Technical Specification Group Radio Access Network’ can be referred to.

Referring to FIG. 1, E-UMTS consists of a user equipment (UE), a cell (eNode B: eNB) and an access gateway (AG) provided to an end terminal of a network (E-UTRAN) to be connected to an external network. Generally, the eNB is able to simultaneously transmit multi-data stream for a broadcast service, a multicast service and/or a unicast service.

The AG can be divided into a part in charge of a user traffic processing and a part in charge of a control traffic. In particular, using a new interface, a communication can be performed between AG for a new user traffic processing and an AG fro processing a control traffic. The AG manages mobility of a user equipment by TA (tracking area) unit. In this case, the TA includes a plurality of cells. When a user equipment moves away from a specific TA into another TA, the user equipment informs an AG that the UE-situated TA has been changed.

A core network (CN) can consist of an AG, a network node for user registration of a user equipment and the like. And, it is able to use an interface for discerning E-UTRAN and CN from each other.

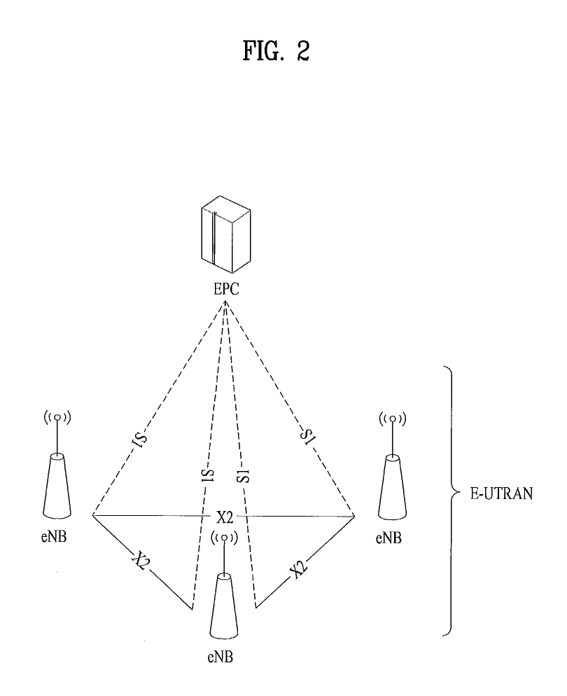

FIG. 2 is a conceptional diagram of a network structure of E-UTRAN (evolved universal terrestrial radio access network). In particular, the E-UTRAN system is the system evolved from a conventional UTRAN system. The E-UTRAN includes cells (e.g., eNBs). And, the cells are connected via an X2 interface with each other Each of the cell is connected to a user equipment via a radio interface and is also connected to an evolved packet core (EPC) via an S1 interface.

The EPC includes MME (Mobility Management Entity), S-GW (Serving-Gateway) and PDN-GW (Packet Data Network-Gateway). The MME has an information of a user equipment or an information on capability of the user equipment. Such information is mainly used for management of mobility of the user equipment. The S-GW is a gateway having the E-UTRAN as a terminal end point. And, the PDN-GW is a gateway having a packet data network (PDN) as a terminal end point.

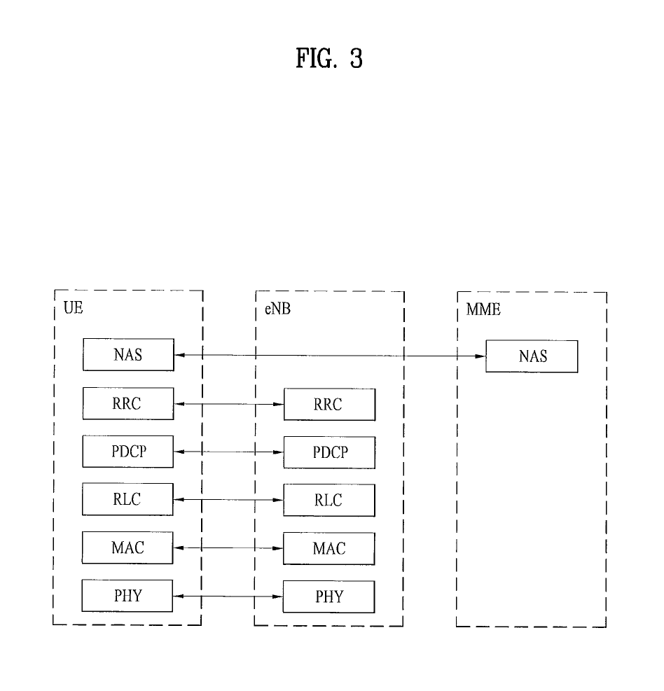

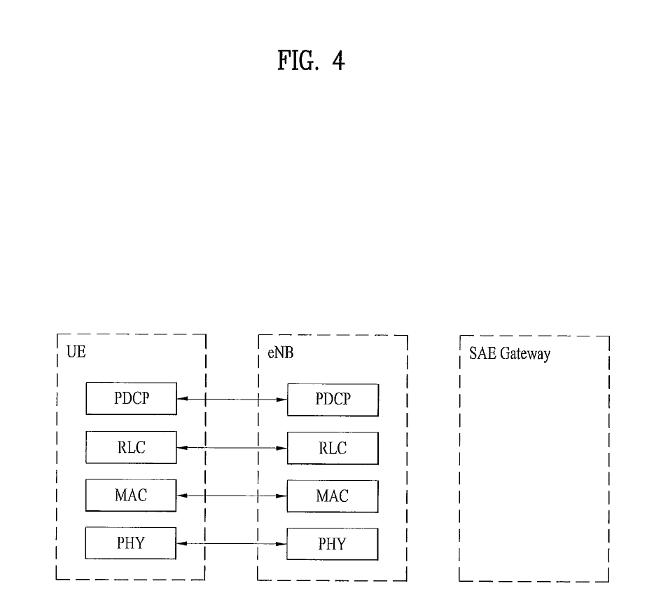

FIG. 3 and FIG. 4 are diagrams of structures of control and user planes of a radio interface protocol between a user equipment and E-UTRAN based on 3GPP radio access network specification. Referring to FIG. 3 and FIG. 4, a radio interface protocol is vertically constructed with a physical layer, a data link layer and a network layer. And, the radio interface protocol can be horizontally divided into a user plane (hereinafter abbreviated U-plane) for a data information transfer and a control plane (hereinafter abbreviated C-plane) for a delivery of a control signal (i.e., signaling).

The protocol layers shown in FIG. 3 and FIG. 4 can be divided into a first layer L1, a second layer L2 and a third layer L3 based on three lower layers of OSI (open system interconnection) reference model widely known in communication systems.

The control plane means a passage for transporting control messages used for a user equipment and a network to manage calls. And, the user plane means a passage for transporting such data generated from an application layer as voice data, internet packet data and the like. In the following description, the layers of the radio protocol control plane and the layers of the radio protocol user plane are explained.

First of all, a physical layer of the first layer provides an information transfer service to an upper layer using a physical channel. The physical layer is connected to a medium access control (MAC) layer above the physical layer via a transport channel. And, data is transported between the medium access control layer and the physical layer through the transport channel. Data is transported between a physical layer of a transmitting side and a physical layer of a receiving side through the physical channel. The physical layer is modulated by OFDM (orthogonal frequency division multiplexing) scheme and utilizes time and frequency as radio resources.

A medium access control (hereinafter abbreviated MAC) of the second layer provides a service to a radio link control layer, which is an upper layer, via a logical channel. The radio link control layer (hereinafter abbreviated RLC) of the second layer supports a reliable data transport. And, a function of the RLC layer can be implemented with a function block within the MAC layer. In this case, the RLC layer may not exist. A PDCP (packet data convergence protocol) layer of the second layer performs a header compression function for reducing unnecessary control information, to efficiently transmit such an IP packet as IPv4, IPv6 and the like in a radio interface having a narrow bandwidth.

A radio resource control (hereinafter abbreviated RRC) layer situated at the bottom of the third layer is defined in a control plane only. The RRC layer is responsible for controlling logical channels, transport channels and physical channels in association with configuration, reconfiguration and release of radio bearers (hereinafter abbreviated RBs). In this case, the RB means a service provided by the second layer for the data delivery between the UE and the E-UTRAN. For this, the RRC layers exchange RRC messages between the UE and the network.

In FIG. 3, NAS (non-access stratum) layer above the RRC layer performs such a function as session management, mobility management and the like. And, the NAS layer exists in MME (mobility management entity) of the UE and the network.

The MME is a core control-node in LTE access network. The MME is in charge of a tracking and paging process and the like for a UE in an idle mode. The MME is involved in a radio bearer activating/deactivating process and is responsible for a serving gateway (SGW) selection for a UE in case of ‘Initial Attach’ or an intra-LTE handover including a core network relocation. The MME is responsible for UE authentication through mutual action with a home subscriber server (HSS). NAS signaling is terminated at the MME. The MME generates a temporary identifier and then allocates the generated temporary identifier to the UE. The MME checks whether the UE has an authority for camping on PLMN (public land mobile network) of a service provider. The MME is an end point encryption/integrity protection for the NAS signaling and is in charge of security key management. And, the MME provides a control plane function for mobility between LTE and 2G/3G access network.

In the NAS layer, two kinds of states including EMM (EPS mobility management) registered state (EMM-REGISTERED) and EMM unregistered state (EMM-UNREGISTERED) are defined. And, the two states are applied to the UE and the MME. In an early stage, UE is in an EMM-unregistered state. In order for the UE to access a network, the UE performs a process for registering for a corresponding network through an ‘initial attach’ procedure. If the attach procedure is successfully completed, the UE and the MME are in the EMM-REGISTERED state.

In the NAS layer, two kinds of states including ECM (EPS connection management) idle state (ECM_IDLE) and ECM connected state (ECM_CONNECTED) are defined to manage a signaling connection between UE and EPC. And, the two kinds of the states are applied to UE and MME. If a UE in ECM idle state establishes RRC connection with E-UTRAN, the corresponding UE enters ECM connected state. If MME in ECM idle state establishes S1 connection with E-UTRAN, it enters ECM connected state. When UE is in ECL idle state, E-UTRAN does not have a context of the UE. Hence, the UE in the ECM idle state performs a mobility related procedure such as a cell selection procedure, a cell reselection procedure and the like without receiving a command from a network. On the contrary, if the UE is in the ECM connected state, mobility of the UE is managed in accordance with the command from the network. In case that a location of UE in ECM idle state becomes different from a location recognized by a network, the UE informs the network of its corresponding location through a TA (tracking area update) procedure.

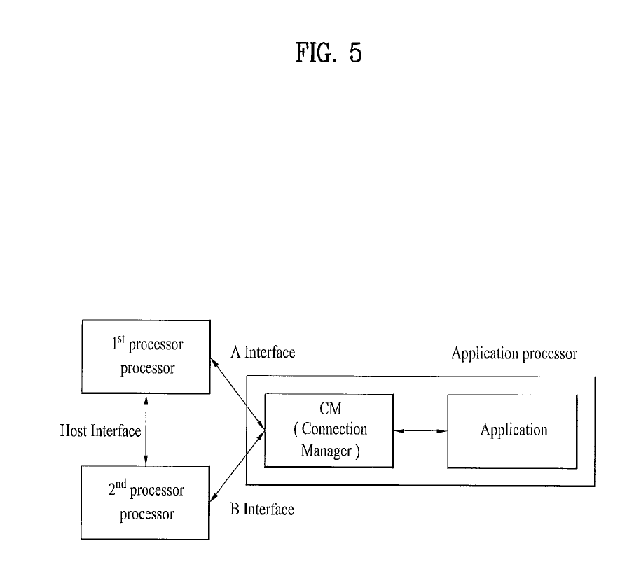

FIG. 5 is a conceptional block diagram for a configuration of a dual mode terminal.

Referring to FIG. 5, a dual mode terminal includes an application processor, an LTE processor for processing a signal received from an LTE network, and a CDMA processor for processing a signal received from a CDMA network.

The application processor can be configured with a single module by hardware within the dual mode terminal or can be configured by being included in a PC independently from the dual mode terminal. The application processor is able to include a connection manager (CM) for managing and controlling a status of an access to the CDMA network or the LTE network in accordance with a network configuration.

In particular, the CM plays a switching role for transmitting and receiving data between an application and one of two processors (i.e., the CDMA processor or the LTE processor) in accordance with a network access status. In more particular, in case that the dual mode terminal is connected to the CDMA network, application data is transmitted and received via an interface A to connect the CDMA processor and the application to each other. In case that the dual mode terminal is connected to the LTE network, the application data is transmitted and received via an interface B to connect the LTE processor and the application to each other.

A host interface is situated between the CDMA processor and the LTE processor and is usable for control and data signal transmissions between the processors.

Meanwhile, the demand for a use of radio waves keeps increasing owing to the remarkable development of the wireless communication technology. And, the radio waves are widely used for the medical industry, traffic control and daily life as well as for communications and broadcasting fields. Thus, as the use of electric devices rapidly increases, the electromagnetic waves radiating from the radio wave use facilities and devices have considerable influence on human body. Specifically, in case of a mobile communication device, U.S. FCC (Federal Communication Commission) adopts the guideline for environmental influence evaluation on radio frequency radiation of FCC 96-326 to regulate a limit for local power absorption applicable to a random mobile transmitting device. In this case, the limit of maximum allowable exposure is based on the exposure evaluation reference quantified into a specific absorption rate (SAR) that is a measure of a radio frequency (RF) energy absorption rate. In case that electromagnetic waves are applied to a human body, the quantity evaluation on the electromagnetic waves is performed by power measurement, electromagnetic field analysis and SAR measurement through animal tests and the like. In this case, the SAR is represented as absorption power per unit mass, which is absorbed in a human body exposed to an electromagnetic field in general.

CENELEC (Comit'e Europeen de Normalisation Electrotechnique) regulates SAR condition as the requirement for the suitability evaluation on a mobile communication terminal as well as U.S. FCC. Thus, U.S. FCC, CENELEC and the like specify the SAR condition as an important item for the suitability evaluation on the mobile communication terminal despite differing in a reference value of the SAR condition. Therefore, the mobile communication terminal should meet the SAR condition or rules.

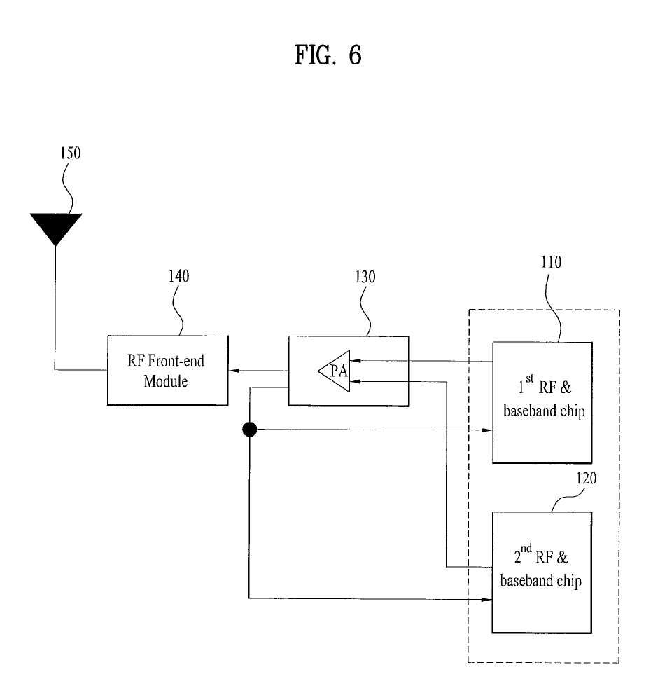

FIG. 6 is a diagram for a configuration of a dual mode terminal according to the present invention.

Referring to FIG. 6, a terminal 600 can include a first RF & baseband chip 610, a second RF & baseband chip 620, a power amplifier 630, an RF front-end module 640 and an antenna 650.

In wireless communications, electromagnetic waves on a specific frequency band are used. Each of the first and second RF & baseband chips 610 and 620 modulates an original signal (i.e., a baseband signal) into a signal on a high frequency band in a signal transmitting process and also demodulates a received high frequency signal into a baseband signal in a signal receiving process. In particular, a baseband chip processes a baseband signal and an RF chip is able to modulate/demodulate the signal processed on a baseband. Both of the RF chip and the baseband chip can be implemented on a single chip, as shown in FIG. 6. Alternatively, the RF chip and the baseband chip can be implemented in a manner of being separated into different chips, respectively.

As mentioned in the above description, each of the first and second RF & baseband chips 610 and 620 performs a modulating/demodulating function in a manner of processing an original signal into a signal on a high frequency band in a signal transmitting process and also processing a signal on a high frequency band into a signal on a baseband in a signal receiving process.

In case that the terminal 600 needs to simultaneously transmit a signal on a plurality of frequency bands, the first RF & baseband chip 610 performs a function of processing an original signal into a signal on a first frequency band for a first communication network and the second RF & baseband chip 620 is able to perform a function of processing the original signal into a signal on a second frequency band for a second communication network, simultaneously. Thus, in a transmitting process if the terminal 600 via a plurality of the frequency bands, the signals processed on high frequency band via the first and second RF & baseband chips 610 and 620 are transmitted on different frequency bands, respectively. In generally, when the terminal 100 transmits a signal on a plurality of frequency bands simultaneously, different wireless communication systems or different radio access technologies (RAT) can be applied to different frequency bands, respectively.

In the configuration of the terminal shown in FIG. 6, the first RF & baseband chip 610 and the second RF & baseband chip 620 are separated into different chips, respectively. Alternatively, the first RF & baseband chip 610 and the second RF & baseband chip 620 can be implemented in a manner of being integrated into a single chip.

The power amplifier (PA) 630 plays a role in amplifying the signals received from the first and second RF & baseband chips 610 and 620 by being processed into signals on first and second frequency bands, respectively.

The second RF & baseband chip 620 receives the signal, which are processed into the signal on the first frequency band by the first RF & baseband chip 610 and then amplified by the power amplifier 630, and is then able to perform a function of measuring a power value of the received signal. The transmission power value of the signal transmitted via the second RF & baseband chip 620 varies by depending on the power value of the signal transmitted from the first RF & baseband chip 610 in accordance with the SAR rules. Thus, the configuration of controlling the transmission power value of the signal to be transmitted by the second RF & baseband chip 620 can be implemented in accordance with a power control device or module within the second RF & baseband chip 620 or can be controlled by a separated power control device independently.

The RF front-end module 640 is able to play a role in enabling free transmission and reception of the terminal 600 and calls of the terminal 600 in various environments. The RF front-end module 640 is able to separate transceived signals in a manner of connecting each of the first and second RF & baseband chips 610 and 620 to the antenna 650 in the terminal 600. The RF front-end module 640 includes a receiving stage front-end module having a built-in received signal filtering filter as a module configured to play a filtering role and a transmitting stage front-end module having a built-in power amplifier 630 for amplifying a transmission signal as a mobile configured to play an amplifying role. The above-configured RF front-end module 640 is mainly used for a GSM (global system for mobile communications) terminal of TDMA (time division multiple access) which should switch transmitted and received signals by switching them to each other.

The RF front-end module 640 is usable to transmit signals on multiple frequency bands like the terminal 600 described in the present invention. For instance, the RF front-end module 640 enables the terminal 600 to use both of LTE and CDMA. If the above-described RF front-end module 640 is used, it is able to decrease the number of parts of the terminal 600. And, it is able to raise the reliability of the terminal 600. Moreover, it is able to reduce the loss due to the interconnection between the parts.

The RF front-end module 640 remarkably improves the battery consumption by reducing power consumption and also enables multiple frequency bands and downsized parts of a multi-functional terminal. The RF front-end module 640, as shown in FIG. 6, is able to transmit the signals, which are processed on a plurality of frequency bands and then received from the power amplifier 630, via the antenna 650, respectively.

Although FIG. 6 shows only one antenna 650, the terminal 600 can include a plurality of antennas.

In general, a terminal in a wireless communication system needs to abide by Specific Absorption Rate (hereinafter abbreviated SAR) rules even if transmitting signals on at least two frequency bands simultaneously. For this, a dual mode terminal according to the present inventions measures a power of a first frequency band for a first RAT (radio access technology) and a power of a second frequency band for a second RAT and then saves the measured power values. And, the dual mode terminal is able to previously determine how mush power will be backed off in accordance with the power of each of the two frequency bands. In this case, the value of the power to be backed off in accordance with the power of the corresponding frequency band is preferably defined in advance in such a format as a table and the like.

For instance, when a terminal transmits a signal on a first frequency band with a maximum power, a power of a second frequency band different from the first frequency band will apply to a power backoff as maximal as possible. Likewise, when the terminal transmits a signal on the second frequency band with a maximum power, a power of the first frequency band will apply to a power backoff as maximal as possible.

Moreover, in case that a terminal transmits a signal on one frequency band not with a maximum power but with a specific power value, a quantity of a power backoff, which will apply to the other frequency band, can be determined in advance.

Yet, according to the above-mentioned power back-off, a resource insufficient condition may occur due to a reduced power of a signal transmitted by each RAT. Hence, there is a problem that possibility of an occurrence of a bandwidth loss exists.

Moreover, if a session of CDMA eHRPD is maintained, it is able to reduce eHRPD session configuration time in case of inter-heterogeneous network handover (iRAT HO) between LTE network and eHRPD network. Hence, it is advantageous in that a total inter-heterogeneous network handover time. For this, a session reconfiguration process should be performed with a base station each time the eHRPD session reconfiguration is necessary. However, if the session reconfiguration process is performed every time, a transmission to the LTE network and a transmission to the CDMA eHRPD network may occur simultaneously, thereby causing the above-mentioned SAR exceeding problem.

Therefore, the present invention proposes a method of preventing a case that a transmission to the LTE network and a transmission to the CDMA eHRPD network take place simultaneously.

In particular, if an activated RAT is LTE network, LTE has a priority higher than that of CDMA eHRPD. Hence, in an RRC connected state with the LTE network, even if an event of a transmission to the CDMA eHRPD occurs, the corresponding event is not performed. For example, the eHRPD event can include one of a change of subnet, a session reconfiguration and the like. Meanwhile, in case that the RRC connection to the LTE network is disconnected (i.e., the transmission to the LTE network is not performed), an event of a transmission to the CDMA eHRPD is performed. Namely, such a condition that the RRC connection is disconnected from the LTE network is added to the event of the transmission to the CDMA eHRPD. Meanwhile, information on the occurrence of the event of the transmission to the CDMA eHRPD is shared between LTE modem and CDMA modem.

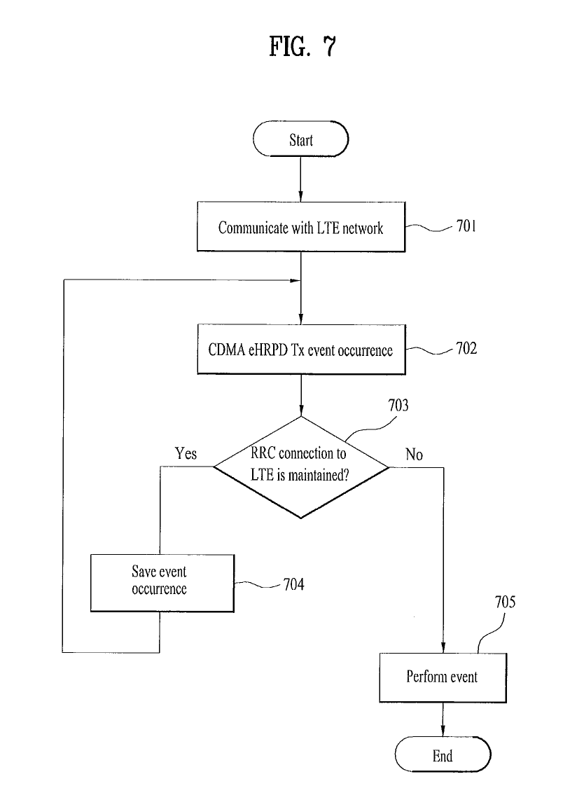

FIG. 7 is a flowchart for an operation of a dual mode terminal according to an embodiment of the present invention.

Referring to FIG. 7, a dual mode terminal according to the present invention is communicating with an LTE network (i.e., assume that an activated RAT is the LTE network) [S701]. Subsequently, an event of a transmission to CDMA eHRPD can occur periodically or non-periodically in the dual mode terminal [S702]. Likewise, the eHRPD transmission event can include a change of subnet, a session reconfiguration and the like for example.

In such a case, the dual mode terminal of the present invention determines whether an RRC connection with the LTE network is currently maintained [S703]. In particular, the event of the transmission to the CDMA eHRPD depends on a presence or non-presence of an RRC connection to the LTE network.

If the RRC connection to the LTE network is currently maintained, the event of the transmission to the CDMA eHRPD is not performed but an occurrence of the event of the transmission to the CDMA eHRPD is saved in a buffer to meet the SAR rules [S704]. Later, if the RRC connection to the LTE network is disconnected, the dual mode terminal is able to perform the event of the transmission to the CDMA eHRPD, which is saved in the buffer.

Meanwhile, if it is determined that the RRC connection to the LTE network is currently disconnected in the step S703, the dual mode terminal is able to perform the transmission to the CDMA eHRPD to perform the occurring event [S705].

Meanwhile, in case that both of a transmission to LTE network and a transmission to CDMA eHRPD network take place simultaneously, the dual mode terminal of the present invention determines whether SAR exceeding problem occurs and is then able to perform the procedure shown in FIG. 7. For instance, if an event of a transmission to CDMA eHRPD occurs periodically or non-periodically in the course of a communication with LTE network, the dual mode terminal of the present invention determines whether a sum of a transmission power to the LTE network and a transmission power to the CDMA eHRPD network is equal to or greater than a preset value. If the sum is smaller than the preset value, the dual mode terminal of the present invention is able to perform a simultaneous transmission to both of the LTE network and the CDMA eHRPD network. On the contrary, if the sum of the transmission power to the LTE network and the transmission power to the CDMA eHRPD network is equal to or greater than the preset value, the dual mode terminal of the present invention does not perform the event of the transmission to the CDMA eHRPD but saves an occurrence of the event of the transmission to the CDMA eHRPD in the buffer.

Embodiments of the present invention can be implemented using various means. For instance, embodiments of the present invention can be implemented using hardware, firmware, software and/or any combinations thereof.

In case of the implementation by hardware, one embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, one embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various well-known means.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be substituted with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dual mode terminal in a wireless communication system, comprising:
a first communication module configuring to transceive a signal with an LTE (long term evolution) network;
a second communication module configuring to transceive a signal with a CDMA (code divisional multiple access) eHRPD (enhanced high-rate packet data) network; and
a processor configured to process the signal corresponding to the first communication module and the signal corresponding to the second communication module, the processor, when the first communication module is activated, controlling a signal transmission event to the CDMA eHRPD network to be performed only if an RRC (radio resource control) connection to the LTE network is disconnected.

2. The dual mode terminal of claim 1, wherein the signal transmission event to the CDMA eHRPD network in the second communication module is a subnet change event for the dual mode terminal.

3. The dual mode terminal of claim 1, wherein the signal transmission event to the CDMA eHRPD network in the second communication module is a CDMA eHRPD session reconfiguration event.

4. The dual mode terminal of claim 1, further comprising a buffer configured to save a presence or non-presence of an occurrence of the signal transmission event to the CDMA eHRPD network if the RRC connection to the LTE network is maintained in case of the occurrence of the signal transmission event to the CDMA eHRPD network.

5. The dual mode terminal of claim 4, wherein if the RRC connection to the LTE network is disconnected, the processor controls the signal transmission event to the CDMA eHRPD network, which is saved in the buffer, to be performed.

6. The dual mode terminal of claim 1, wherein when an occurrence of the signal transmission event to the CDMA eHRPD is detected, if a sum of a transmission power to the LTE network and a transmission power to the CDMA eHRPD network is smaller than a preset value, the processor controls the signal transmission event to the CDMA eHRPD network to be performed.

7. A method of controlling a dual mode terminal in a wireless communication system, comprising the steps of:
activating a first communication module configuring to transceive a signal with an LTE (long term evolution) network;
detecting an occurrence of a signal transmission event to the CDMA eHRPD network by a second communication module configuring to transceive a signal with a CDMA (code divisional multiple access) eHRPD (enhanced high-rate packet data) network;
determining a presence or non-presence of an RRC (radio resource control) connection to the LTE network; and
if the RRC connection is disconnected, performing the signal transmission event to the CDMA eHRPD network in the second communication module.

8. The method of claim 7, wherein the signal transmission event to the CDMA eHRPD network in the second communication module is a subnet change event for the dual mode terminal.

9. The method of claim 7, wherein the signal transmission event to the CDMA eHRPD network in the second communication module is a CDMA eHRPD session reconfiguration event.

10. The method of claim 7, further comprising the step of saving a presence or non-presence of the occurrence of the signal transmission event to the CDMA eHRPD network if the RRC connection to the LTE network is maintained in case of the occurrence of the signal transmission event to the CDMA eHRPD network.

11. The method of claim 10, further comprising the step of if the RRC connection to the LTE network is disconnected, performing the signal transmission event to the CDMA eHRPD network.

12. The method of claim 7, further comprising the step of when the occurrence of the signal transmission event to the CDMA eHRPD is detected, if a sum of a transmission power to the LTE network and a transmission power to the CDMA eHRPD network is smaller than a preset value, performing the signal transmission event to the CDMA eHRPD network.
